(19) United States
(12) Patent Application Publication
(10) Pub. No.: US 2026/0351994 A1
(43) Pub. Date: Nov. 5, 2026

(54) Electronic Device for Supporting Power Transaction and Method Thereof

(71) Applicant: LG Energy Solution, Ltd., Seoul (KR)

(72) Inventor: Yunson Hwang, Daejeon (KR)

(73) Assignee: LG Energy Solution, Ltd., Seoul (KR)

(21) Appl. No.: 19/708,194

(22) Filed: Jun. 15, 2026

Related U.S. Application Data
(63) Continuation of application No. PCT/KR2025/009503, filed on Jul. 3, 2025.

(30) Foreign Application Priority Data
Jul. 9, 2024 (KR) 10-2004-0090330

(51) Int. Cl. H02J 7/50; H02J 7/80

(52) U.S. Cl. CPC H02J 7/50; H02J 7/80

(57) ABSTRACT

Disclosed is an electronic device for supporting power transaction, the electronic device including: a transceiver; a processor; and a memory for storing one or more instructions, wherein the one or more instructions are configured to, when executed, cause the processor to: identify a plurality of power prediction data during a first period corresponding to a plurality of energy storage systems (ESSs), respectively; identify, based on first power prediction data during the first period corresponding to a first ESS among the plurality of ESSs, at least one second ESS matching the first ESS; identify power transfer ready information from each of a first terminal associated with the first ESS and a second terminal associated with the second ESS; and determine whether to perform power exchange between the first ESS and the second ESS, on the basis of the power transfer ready information identified from the first terminal and the second terminal.

### CROSS-REFERENCE TO RELATED APPLICATIONS

This application is a continuation of International Application No. PCT/KR2025/009503, filed on Jul. 3, 2025, which claims priority to Korean Patent Application No. 10-2024-0090330, filed on Jul. 9, 2024, in the Korean Intellectual Property Office, the contents of which are incorporated herein by reference in its entirety.

### BACKGROUND

Self-electric power generating facilities generate their own electricity on-site via various technologies, such as solar panels, wind turbines, hydropower, and more. Such on-site electric energy generation are closely linked with energy storage systems (ESS) that manage storage, usage, and supply of the electricity at each facility. The self-electric power generation and their storage allow independence from traditional energy infrastructure and can be cost saving. However, reliable supply of electricity and/or energy equilibrium between available energy and consumption are some considerations for employing such system. For example, accumulation of surplus electric power without usage may be waste of resources. Therefore, a platform for supporting management and distribution of the generated electric power between ESSs for controlled power flow of a surplus electric power, supplying the same, and increasing utilization of electric power resources is desired.

### BRIEF SUMMARY

The present disclosure provides an electronic device for supporting an electric power exchange and transfer and a method thereof. More specifically, the disclosure involves a platform system which enables an electric power transfer between individuals having ESSs in a more effective and efficient manner by accumulating data of an electric power generation amount and consumption amount according to historical climate circumstances, and estimating, based on the data thereof, a future electric power surplus amount or electric power shortage amount. The present disclosure accurately determines a status of electric power storage for future time periods such that power exchanges may occur efficiently, in some aspects, in real-time or near real-time. According to the present disclosure, the electronic device may estimate electric power at a plurality of ESS and match ESS of complementary electric powers, thereby reducing communications and power transfers among unmatched ESSs. In addition, the effective monitoring and management of electric power exchange sufficiently and reliably supply electric power at ESS without undesired disruptions.

An aspect of the present disclosure is an electronic device for an electric power transfer, the electronic device including a transceiver, a processor, and a memory storing at least one instruction, wherein, when the at least one instruction is executed by the processor, the processor is configured to identify a plurality of electric power estimation data during a first period which correspond to each of a plurality of energy storage systems (ESS), identify, based on first electric power estimation data of the plurality of electric power estimation data during the first period of a first ESS of a plurality of ESSs, at least one second ESS that match the first ESS, identify electric power transfer ready information from a first terminal associated with the first ESS and a second terminal associated with the second ESS, and determine, based on the electric power transfer ready information identified from the first terminal and the second terminal, to perform an electric power exchange between the first ESS and the second ESS.

In some examples of the present disclosure is the electronic device, wherein the processor is further configured to control, based on determining to perform the electric power exchange between the first ESS and the second ESS, the first ESS and the second ESS in order for an electric power exchange to occur by an electric power amount defined between the first ESS and the second ESS.

In some examples of the present disclosure is the electronic device, wherein the processor is further configured to obtain the first electric power estimation data during a first period of the first ESS that are outputted from an artificial intelligence engine based on weather prediction data of the first period of a region corresponding to a location of the first ESS that are inputted in the artificial intelligence engine, wherein the artificial intelligence engine is an artificial intelligence model which is constructed by learning a correlation between weather data during a second period of a region corresponding to a location of at least one ESS of the plurality of ESSs and electric power data corresponding to the second period with respect to the at least one ESS of the plurality of ESSs, wherein the electric power data includes at least one of a power generation amount, a charge amount, a discharge amount, and a facility electric power consumption amount.

In some examples of the present disclosure is the electronic device, wherein the correlation between the weather data during the second period and the electric power data includes a first correlation related to a proportionality with respect to a solar radiation quantity of a solar power generation amount that is inversely proportional to a temperature thereof, a second correlation relates to a proportionality with respect to wind speed of a wind power generation amount, and a third correlation with respect to a U letter-shaped relationship with respect to a temperature of the facility electric power consumption amount, wherein the solar power generation amount and the wind power generation amount is at least a portion of the power generation amount.

In some examples of the present disclosure is the electronic device, wherein the weather prediction data include at least one of a temperature, a sunshine amount (solar radiation quantity), and a wind speed which are predicted with respect to the first period of the region.

In some examples of the present disclosure is the electronic device, wherein, the processor is further configured to determine, based on the first electric power estimation data, electric power supply data for each unit time of unit times which are estimated with respect to the first period of the first ESS, wherein the electric power supply data for each unit time include data estimating whether a facility electric power consumption amount of the first ESS is supplied with an electric power amount of the first ESS and a power generation amount corresponding to the first ESS for the each unit time, identify, based on the electric power supply data for each unit time, at least one ESS determined to have an electric power supply state that is opposite to that of a first ESS in at least one portion of the unit times, and identify, based on condition information of the first ESS, the at least one second ESS of the at least one ESS determined to have the electric power supply state that is opposite to that of the first ESS.

In some examples of the present disclosure is the electronic device, wherein the processor is further configured to determine the electric power supply data for each unit time based on the first electric power estimation information, wherein the electric power supply data further includes a sum of the electric power amount of the first ESS and the power generation amount corresponding to the first ESS and a value estimated by a difference of the sum and the facility electric power consumption amount by the each unit time.

In some examples of the present disclosure is the electronic device, wherein the processor is further configured to identify the at least one second ESS that matches at least one condition included in the condition information of the first ESS, wherein the condition in the condition information is any one of a cost condition, a distance condition, a compatibility condition and a connection condition, and wherein the at least one second ESS is of the at least one ESS estimated to have an electric power supply state that is opposite to that of the first ESS in the at least one portion of the unit time.

In some examples of the present disclosure is the electronic device, wherein the processor is further configured to identify that a magnitude of the value estimated by the difference of the sum and the facility electric power consumption amount by each unit time is equal to or greater than a threshold value, and identify, with respect to the at least one portion of the unit time during which the magnitude of the value estimated by the difference is equal to or greater than the threshold value, the at least one second ESS without applying at least one condition included in the condition information.

In some examples of the present disclosure is the electronic device, wherein the processor is further configured to determine that an electric power supply state of the first ESS corresponds to an electric power shortage in at least one portion is a peak time zone of the unit times, and identify, with respect to the at least one portion corresponding to the peak time zone of the unit time in which the electric power supply state of the first ESS corresponds to an electric power shortage, the at least one second ESS without applying at least one portion of the condition included in the condition information.

In some examples of the present disclosure is the electronic device, wherein the processor is further configured to transmit transfer information related to the electric power exchange between the first ESS and the second ESS to each of the first terminal and the second terminal, and identify the electric power transfer ready information including information indicating a decision for an electric power transfer and an electric power amount to be transferred based on the electric power transfer information from each of the first terminal and the second terminal.

Another aspect of the present disclosure provides a method for an electric power transfer of an electronic device, the method including identifying a plurality of electric power estimation data during a first period of a plurality of ESSs, identifying at least one second ESS that match a first ESS based on first electric power estimation data during the first period of the first ESS of a plurality of ESSs, identifying, based on first electric power estimation data of the plurality of electric power estimation data during the first period of a first ESS of the plurality of ESSs, at least one second ESS that matches the first ESS, identifying electric power transfer ready information from a first terminal associated with the first ESS and a second terminal associated with the second ESS, and determining, based on the electric power transfer ready information identified from the first terminal and the second terminal, to perform an electric power exchange between the first ESS and the second ESS.

Yet another aspect of the present disclosure provides for a non-transitory computer-readable non-transitory storage medium storing information that, when executed by a processor, cause the processor to perform a method for an electric power transfer on a computer, the method includes: identifying a plurality of electric power estimation data during a first period of a plurality of ESSs, identifying, based on first electric power estimation data of the plurality of electric power estimation data during the first period of a first ESS of a plurality of ESSs, at least one second ESS that matches with the first ESS, identifying electric power transfer ready information from a first terminal associated with the first ESS and a second terminal associated with the second ESS, and determining, based on the electric power transfer ready information identified from the first terminal and the second terminal, to perform an electric power exchange between the first ESS and the second ESS.

In some examples of the present disclosure, the method includes controlling, based on determining to perform the electric power exchange between the first ESS and the second ESS, the first ESS and the second ESS in order for an electric power exchange to occur by an electric power amount defined between the first ESS and the second ESS.

In some examples of the present disclosure, the method includes obtaining the first electric power estimation data during a first period of the first ESS that are outputted from an artificial intelligence engine based on weather prediction data of the first period of a region corresponding to a location of the first ESS that are inputted in the artificial intelligence engine, wherein the artificial intelligence engine is an artificial intelligence model which is constructed by learning a correlation between weather data during a second period of a region corresponding to a location of at least one ESS of the plurality of ESSs and electric power data corresponding to the second period with respect to the at least one ESS of the plurality of ESSs, wherein the electric power data includes at least one of a power generation amount, a charge amount, a discharge amount, and a facility electric power consumption amount.

In some examples of the present disclosure, the method includes determining, based on the first electric power estimation data, electric power supply data for each unit time of unit times which are estimated with respect to the first period of the first ESS, wherein the electric power supply data for each unit time comprise data estimating whether a facility electric power consumption amount of the first ESS is supplied with an electric power amount of the first ESS and a power generation amount corresponding to the first ESS for the each unit time; identifying, based on the electric power supply data for each unit time, at least one ESS determined to have an electric power supply state that is opposite to that of the first ESS in at least one portion of the unit times; and identifying, based on condition information of the first ESS, the at least one second ESS of the at least one ESS determined to have the electric power supply state that is opposite to that of the first ESS.

In some examples of the present disclosure, the method includes determining the electric power supply data for each unit time based on the first electric power estimation information, wherein the electric power supply data further comprises a sum of the electric power amount of the first ESS and the power generation amount corresponding to the first ESS and a value estimated by a difference of the sum and the facility electric power consumption amount by the each unit time.

In some examples of the present disclosure, the method includes identifying the at least one second ESS that matches at least one condition included in the condition information of the first ESS, wherein the condition in the condition information is any one of a cost condition, a distance condition, a compatibility condition and a connection condition, and wherein the at least one second ESS is of the at least one ESS estimated to have an electric power supply state that is opposite to that of the first ESS in the at least one portion of the unit time.

In some examples of the present disclosure, the method includes identifying that a magnitude of the value estimated by the difference of the sum and the facility electric power consumption amount by each unit time is equal to greater than a threshold value; and identifying, with respect to the at least one portion of the unit time during which the magnitude of the value estimated by the difference is equal to greater than the threshold value, the at least one second ESS without applying at least one condition included in the condition information.

In some examples of the present disclosure, the method includes transmitting trading information related to the electric power exchange between the first ESS and the second ESS to each of the first terminal and the second terminal; and identifying the electric power trading intention information comprising information indicating a decision for an electric power trading and an electric power amount to be traded based on the electric power trading intention formation from each of the first terminal and the second terminal.

### BRIEF DESCRIPTION OF THE DRAWINGS

FIG. 1 is a block diagram of an electronic device and various components connected thereto for supporting an electric power transfer according to aspects of the disclosure.

FIG. 2 is a flowchart of a method for supporting an electric power transfer according to aspects of the disclosure.

FIG. 3 is a block diagram of an example of electric power data and weather data collected by a data collecting server according to aspects of the disclosure.

FIG. 4 is a block diagram of an artificial intelligence engine according to aspects of the disclosure.

FIG. 5 is an example table of first electric power estimation data of a first energy storing system (ESS) and second electric power estimation data of an ESS according to an aspect of the disclosure.

FIG. 6 is a block diagram of an electronic device according to aspects of the disclosure.

### DETAILED DESCRIPTION

Terms used in example embodiments are selected from currently widely used general terms when possible while considering the functions in the present disclosure. However, the terms may vary depending on the intention of a person skilled in the art, precedents, the emergence of new technology, and the like. Further, in particular cases, there are also terms arbitrarily selected by the applicant, and in these cases, the meaning will be described in detail in the corresponding descriptions. Therefore, the terms used in the present disclosure are not to be construed simply as its designation but based on the meaning of the term and the overall context of the present disclosure.

Throughout the specification, when a part is described as “comprising or including” a component, it does not exclude another component but may further include another component unless otherwise stated.

As used herein, each of such phrases as “at least one of a, b, or c” may include any one of or all possible combination of items enumerated together, for example, “a alone,” “b alone,” “c alone,” “a and b,” “a and c,” “b and c,” or “all of a, b, and c.”

The “terminal” referred hereinafter may be embodied as a computer or a portable terminal that may access a server or another terminal through a network. Here, the computer may include, for example, a notebook, a desktop computer, and/or a laptop computer which are equipped with a web browser. The portable terminal may be a wireless communication apparatus ensuring portability and mobility and include (but is not limited to) any type of a handheld wireless communication apparatus, for example, a tablet PC, a smartphone, a communication-based terminal such as international mobile telecommunication (IMT), code division multiple access (CDMA), W-code division multiple access (W-CDMA), long term evolution (LTE), or the like.

Aspects of the disclosure are described with reference to the accompanying drawings. The disclosure may be modified in various forms and have various examples, and specific examples thereof are shown by way of drawings and description below. It should be understood, however, that there is no intent to limit the disclosure to the specific examples, but on the contrary, the disclosure is to cover all modifications, equivalents, and alternatives falling within the spirit and technical scope of the disclosure. Like reference numerals refer to like elements throughout the description of the figures. It is to be understood that a singular form of a noun corresponding to an item may include one or more of the things, unless the relevant context clearly indicates otherwise.

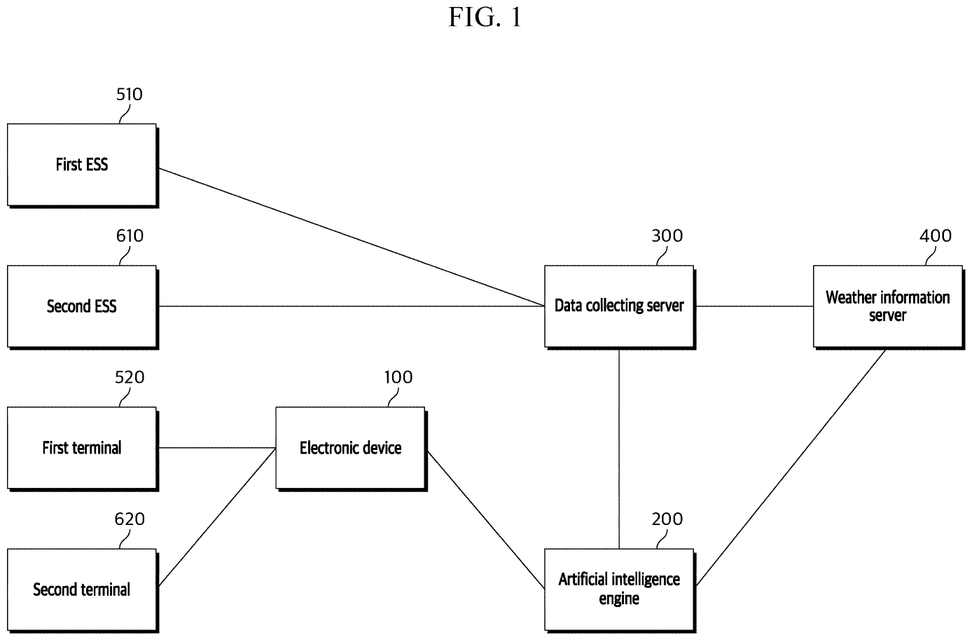

FIG. 1 is a block diagram of an electronic device and various components connected thereto for supporting an electric power transfer according to aspects of the disclosure.

The electronic device 100 may be operatively connected to an artificial intelligence engine 200, a data collecting server 300 and a weather information server 400. The electronic device 100 may be connected to and operate in association with a plurality of energy storage systems (ESS) and a terminal corresponding to each ESS. In FIG. 1, for the sake of convenience in description, only a first ESS 510, a first terminal 520 corresponding to the first ESS 510, a second ESS 610 and a second terminal 620 corresponding to the second ESS 610 are illustrated.

The artificial intelligence engine 200 may perform an operation of being inputted with weather prediction data to output electric power estimation data. The data collecting server 300 may obtain electric power data from a plurality of ESSs to support training the artificial intelligence engine 200, and obtain weather data from the weather information server 400 to store the same. The weather information server 400 may be a server which may identify weather data and weather prediction data by using a self-weather prediction model or being connected to an external weather prediction organization server. The electronic device 100, the artificial intelligence engine 200, the data collecting server 300 and the weather information server 400 which are described above may be operated as servers which are individually and physically divided, and at least one portion thereof may be operated as servers which are logically divided in a physically identical server. For example, the artificial intelligence engine 200 may be implemented as a logical component that executes an artificial intelligence model deployed and hosted at the data collecting server 300, and may be implemented as an artificial intelligence model executed on a device separate from the data collecting server 300 or another server. For simplicity, elements introduced in FIG. 1 are referred to using the corresponding reference number of FIG. 1 herein below.

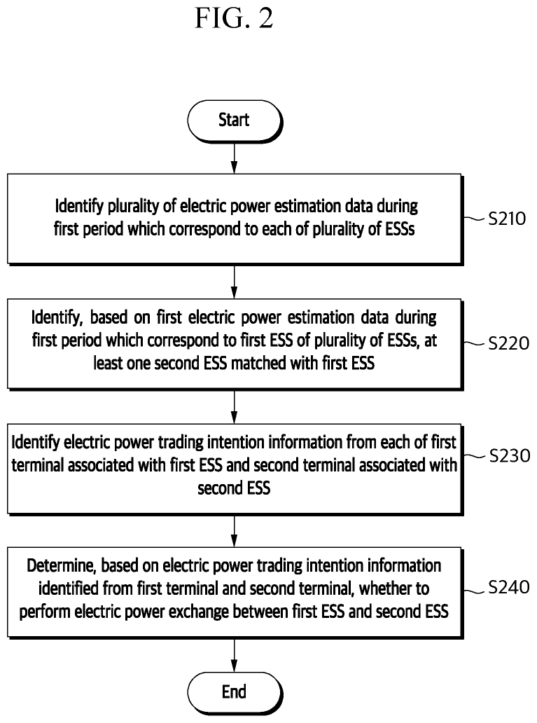

FIG. 2 is a flowchart of a method for determining electric power at energy storage systems (ESSs) to support an electric power transfer according to aspects of the disclosure. The method described herein may be performed at the electronic device having one or more processors.

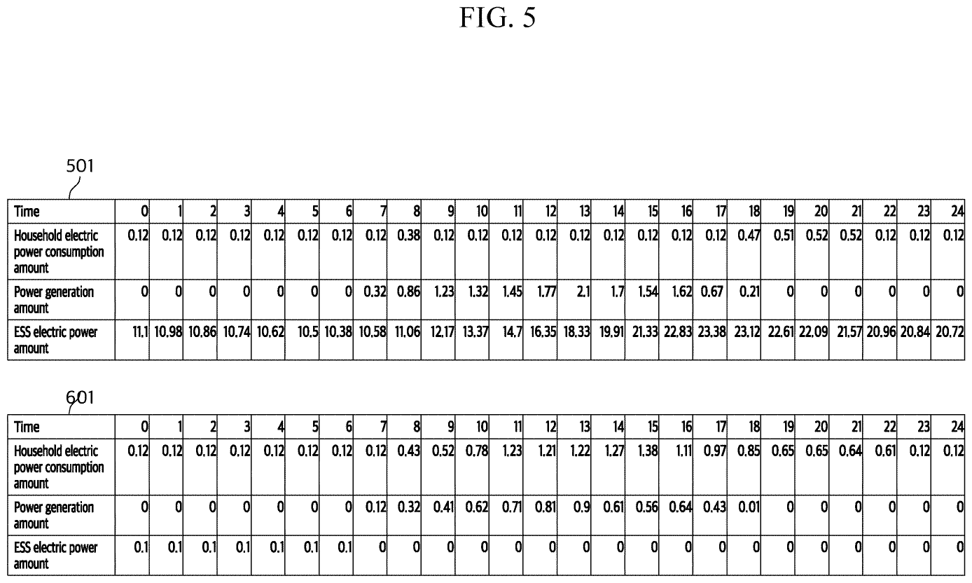

In operation S210, the electronic device 100 may identify a plurality of electric power estimation data during a first period which correspond to each of a plurality of ESSs. Each ESS may be in a state of having been registered to an electric power transfer platform, and, accordingly, each of the plurality of ESSs may be connected to the electronic device 100 through a network. The first period may be a period in the future from a corresponding point in time, and the electric power estimation data may correspond to a power generation amount of a power generator corresponding to each ESS, a charge amount of each ESS, a discharge amount of each ESS, and a facility electric power consumption amount of a facility to which each ESS is connected, which are expected to be measured in the first period with respect to each ESS. An example of each data value is also in FIG. 5 hereinafter. Some examples of a “facility” include businesses, institutions, industrial facilities, residential communities, residential homes, households, and the like, and any combination thereof.

In operation S220, the electronic device 100 may, based on first electric power estimation data during the first period of the first ESS 510 among the plurality of ESSs, identify at least one second ESS 610 that matches with the first ESS 510. Here, the first ESS 510 is an example among the plurality of ESSs, and the second ESS 610 that matches the first ESS 510 may be at least one of the ESSs having an electric power supply state that is opposite to that of the first ESS 510 in a unit time during the first period. As used herein, an “opposite” electric power supply state is when the first ESS is at a surplus power state and the second ESS is at a shortage power state or when the first ESS is at a shortage power state and the second ESS is at a surplus power state. That is, “opposite” electric power supply states are states those that are inverse states to one another. In an aspect, “opposite” states of surplus and/or shortage may be determined by a “negative” or “positive” value of the electric power supply state. It should be noted that two ESSs with “opposite” states may or may not have equal numerical magnitudes (i.e., absolute vales).

In operation S230, the electronic device 100 may identify electric power transfer ready information from each of the first terminal 520, associated with the first ESS 510, and the second terminal 620, associated with the second ESS 610. In an aspect, the electric power transfer ready information, which indicates a power exchange acknowledgement and/or approval, may be respectively inputted into the first terminal 520 and the second terminal 620 by users of the first ESS 510 and the second ESS 610. The electric power transfer ready information may include a content that each user (e.g., owner, etc.) thereof acknowledges and thus defined within upon an electric power transfer according to transfer information delivered to the first terminal 520 and the second terminal 620 to be described hereinafter. That is, the electric power transfer ready information may include a decision for a first electric power transfer as well as power transfer information, such as electric power amount, of the first ESS 510 and the second ESS 610 that is determined according to the present disclosure.

In operation S240, the electronic device 100 may determine, based on the electric power transfer ready information identified from the first terminal 520 and the second terminal 620, whether to perform an electric power exchange between the first ESS 510 and the second ESS 610. Hereinafter, operations and a configuration associated with the operations are described.

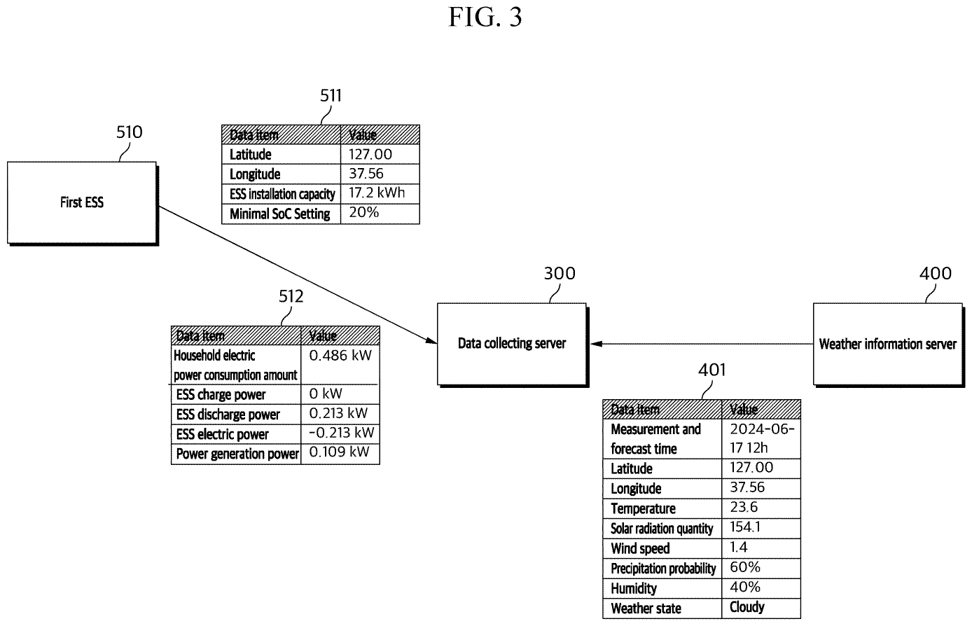

The electronic device 100 may be communicatively connected to the artificial intelligence engine 200 to identify the plurality of electric power estimation data during the first period which correspond to each of the plurality of ESSs. The artificial intelligence engine 200 may be in a trained state based on the electric power data and weather data from the data collecting server 300 as described above. The electric power data and the weather data obtained by the data collecting server 300 will be described with reference to FIG. 3. In aspects of the present disclosure, the artificial intelligence engine 200 may be deployed within the electronic device, outside the electronic device, or both.

FIG. 3 is a block diagram of an example of electric power data and weather data collected by a data collecting server according to aspects of the disclosure.

Basic data 511 and electric power data 512, shown as tables, may be collected from the first ESS 510 of a plurality of ESSs. The first ESS 510 is an example, and the data collecting server 300 may similarly obtain basic data and electric power data from the plurality of other ESSs. The basic data 511 are elementary information of a specific ESS such as, latitude location, longitude location, ESS installation capacity, minimal SOC setting, and more.

The data collecting server 300 may obtain latitude, longitude, ESS installation capacity and minimal state-of-charge (SoC) setting information of the first ESS 510 as basic data 511. The latitude and the longitude information of the first ESS 510 is obtained as location information of the first ESS, and basic data may be obtained also in another method, for instance, in a form of an address and the like. An ESS installation capacity may include information with respect to a capacity of the first ESS 510. Minimal SoC setting information is a minimum SoC value which is set with respect to the first ESS 510, and may signify a setting value at which discharge may not be performed and only charge may be performed when an SoC value of the first ESS 510 decreases to or below a corresponding minimum SoC value. According to an example of FIG. 3, the data collecting server 300 may obtain basic data including 127 degrees of latitude, 37.56 degrees of longitude, 17.2 kilowatt-hours (kWh) of an ESS installation capacity, and 20 percent (%) of a minimal SoC setting with respect to the first ESS 510. Such basic data may be collected by the data collecting server 300 at a point in time at which the plurality of ESSs are initially installed or at an arbitrary point in time afterwards.

The data collecting server 300 may obtain the electric power data 512 that includes information with respect to a facility electric power consumption amount, an ESS charge power, an ESS discharge power, an ESS electric power and a power generation power from the first ESS 510. Such electric power data may be delivered to the data collecting server 300 from the plurality of ESSs for each unit time which is set. For example, the electric power data may be delivered to the data collecting server 300 at a one-minute or several-minute interval, based on the set unit time, from the plurality of ESSs. The facility electric power consumption amount in the electric power data may signify electric power consumed at a facility connected to the first ESS 510 during a unit time corresponding to a corresponding point in time. The ESS charge power may signify an amount by which the ESS is charged with electric power generated by a power generator connected to the first ESS 510 at a corresponding point in time, and the ESS discharge power may signify an amount of electric power which is being discharged from the first ESS 510 at a corresponding point in time. The ESS electric power may be a value subtracting the ESS discharge power from the ESS charge power. A power generation amount may signify an amount generated by a power generator connected to the first ESS 510 at a corresponding point in time, and may include, for example, a solar power generation amount and a wind power generation amount, without being limited thereto. According to an example of FIG. 3, the data collecting server 300 may identify a facility electric power consumption amount indicating that 0.486 kilowatts (kW) are consumed at a facility during a unit time corresponding to a corresponding point in time from the first ESS 510, an ESS charge power indicating that the first ESS 510 is not charged at all during the unit time, an ESS discharge power indicating that the first ESS 510 is discharged by 0.213 kW during the unit time, an ESS electric power indicating −0.213 kW, and a power generation power indicating that a power generator associated with the first ESS 510 has generated electric power by 0.109 kW. Here, the amount discharged from the first ESS 510 being added to the power generation power is smaller than the facility electric power consumption amount, which may indicate that a facility (e.g., household) corresponding to the first ESS 510 has used electric power by receiving the same distributed from an external system at a corresponding point in time.

The data collecting server 300 may obtain weather data 401 from the weather information server 400. According to an aspect, the weather data 401 may be delivered to the data collecting server 300 at an interval of a one-hour or several-hour unit. The weather data may include information with respect to reference time, latitude, longitude, temperature, solar radiation quantity, wind speed, precipitation probability, humidity and weather classification information. The reference time, latitude and longitude information included in the weather data may indicate whether the corresponding weather data are a value obtained by measuring a weather at a particular time and place. The latitude and longitude may be replaced with another form (or type of data) used for indicating a location such as an administrative district. The weather classification information may indicate a weather state of the corresponding time and the corresponding place in a broad framework, for example, as a weather state such as rainy, cloudy, sunny, or misty. For example, the data collecting server 300 may identify weather data 401 indicating 23.6 degrees Celsius of temperature, 154.1 watts (W) of solar radiation quantity for each square meter, 1.4 meters per second (m/s) of wind speed, 60% of precipitation probability, 40% of humidity, and a cloudy weather state with respect to a region around a location of 127 degrees of latitude and 37.56 degrees of longitude at 12 o'clock on Jun. 17, 2024.

The data collecting server 300 may map the collected electric power data and weather data. In other words, the data collecting server 300 may identify the weather data of a location at which the plurality of ESSs is installed based on the basic data (e.g., location), and may map the electric power data obtained from the plurality of ESSs to the weather data of the corresponding location. Here, a time at which the electric power data are obtained and reference time information included in the weather data may be matched to be mapped. For example, the electric power data of the first ESS 510 from 15:00 to 16:00 on Jun. 26, 2024 and the weather data of a region, at which the first ESS 510 is installed, from 15:00 to 16:00 on Jun. 26, 2024 may be mapped. In an aspect, when an obtaining interval of the electric power data and the weather data is identical, each datum may be mapped as it is. In another aspect, when an obtaining interval is different from each other, such as in a case in which the electric power data are obtained at a one-minute or several-minute interval and the weather data are obtained at a one-hour or several-hour interval as described above, the electric power data may be accumulated to correspond to the weather data of longer the obtaining interval for mapping. For example, the electric power data of the first ESS 510, which are obtained every three minutes from 15:00 to 16:00 on Jun. 26, 2024, may be accumulated with respect to the corresponding one hour, before being mapped with the weather data, with respect to the region at which the first ESS 510 is installed, at 15:00 on Jun. 26, 2024, which are obtained every one hour. In some aspects, when the electric power data are in a kWh unit, an average value may be used in order to accumulate the electric power data, obtained by a minute unit as an hour unit. Other methods of accumulating the electric power data may be used without departing from the scope of the present disclosure.

The data collecting server 300, which has collected data as such, may deliver the same to the artificial intelligence engine 200 in order to support training of the artificial intelligence engine 200.

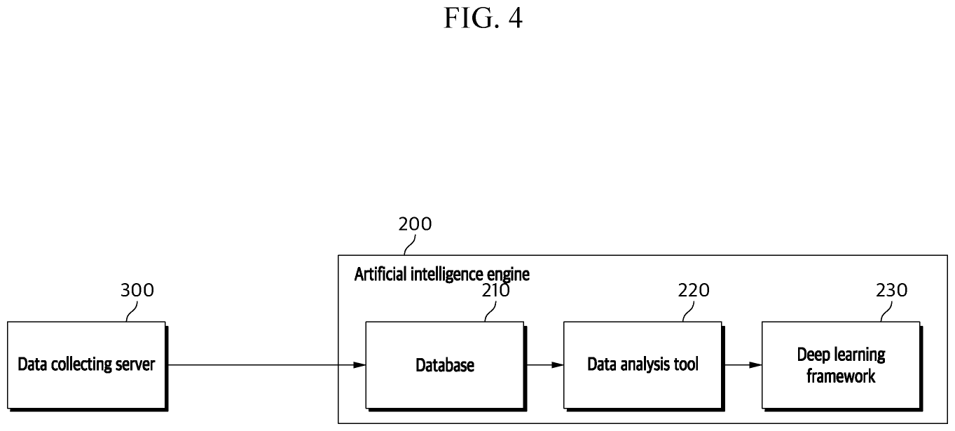

FIG. 4 is a block diagram of an artificial intelligence engine according to aspects of the disclosure.

The artificial intelligence engine 200 may store electric power data and weather data obtained from the data collecting server 300 in a database 210 thereof. In an aspect, the database 210 may be implemented in a time series database (DB) method, a not only structured query language (NoSQL) method or the like, without being limited thereto. The artificial intelligence engine 200 may pre-process the electric power data and the weather data which are stored in the database 210. For example, by performing a pre-processing operation of excluding data which appear as a measurement error, excluding data having an extreme value or a pre-processing operation for processing a missing value and the like, the electric power data and the weather data may be processed as training data. The artificial intelligence engine 200 may extract a pattern of the weather data and the electric power data by using a data analysis tool 220. For example, the artificial intelligence engine 200 may extract a basic statistical feature such as an average, a standard deviation, a maximal value or a minimal value for each item of the weather data and the electric power data, and accumulate data for each time to analyze seasonality and trend. The pattern extraction process is not limited to a process described above. The artificial intelligence engine 200 may cause a recurrent neural network (RNN) included in the same to learn the pattern by using a deep-learning framework 230. For example, the artificial intelligence engine 200 may cause the RNN to learn by inputting, by using the deep-learning framework 230, a pattern of the weather data into the RNN as the training data and back-propagating a loss calculated by comparing a correct answer value identified based on a pattern of the electric power data to a value outputted from the RNN. For example, back-propagation with respect to the RNN may be performed as back-propagation through time.

According to an aspect, the artificial intelligence engine 200 may learn as described above by receiving historical weather data and electric power data associated with a second period in the past, which are stored in the data collecting server 300. Here, the second period may be set in consideration of efficiency of learning. For example, additional second periods of the past may be used until the artificial intelligence engine 200 is determined to be sufficiently trained. During the learning process, the artificial intelligence engine 200 may learn a correlation (or relationship) between weather data and electric powder data during a second period. The weather data may be of a region corresponding to a location of the at least one portion of a plurality of ESSs and the electric power may include at least one portion of a power generation amount, a charge amount, a discharge amount, and a facility electric power consumption amount of the second period with respect to the at least one portion of the plurality of ESSs through a training process. The power generation amount may include a solar power generation amount, a wind power generation amount, and the like, and any combination thereof. For example, the correlation may include a first correlation related to a proportionality with respect to a solar radiation quantity of a solar power generation amount that is inversely proportional to a temperature thereof. In the same example, a second correlation related to a proportionality with respect to wind speed of a wind power generation amount, and a third correlation related to a U letter-shaped relationship with respect to a temperature of the facility electric power consumption amount. Here, a U letter-shaped relation may signify a relation by which, when a temperature section is divided into multiple subsections such as a section with a high temperature, a section with an intermediate temperature, and a section with a low temperature, the facility electric power consumption amount increases at the section with the high temperature and the section with the low temperature. The temperature section may be divided into the multiple sections based on predetermined range of temperatures and/or threshold temperature values. The artificial intelligence engine 200 may learn such relation to output electric power estimation data from the input weather prediction data.

According to an aspect, the artificial intelligence engine 200 may be trained to output electric power estimation data that reflect a facility electric power use amount pattern for each of the plurality of ESSs. In an aspect, the facility electric power use amount pattern may be learned from previous (or historical) data for the facility. For example, an “A” household has household members who often stay at home during the day and “B” household has household members who are not at home during the day. In such a scenario, the “A” household may have a greater electric power use amount than the “B” household during the summertime caused by longer air conditioner operations even during the day. In order for the artificial intelligence engine 200 to output electric power estimation data reflecting such facility electric power use amount pattern, according to an aspect, the artificial intelligence engine 200 may be implemented in a manner of training by segregating weather data and electric power data for each of the plurality of ESSs, a manner of using the same by learning a model for each of the plurality of ESSs, or a manner of using identification information for each of the plurality of ESSs as an input together, but the training may not be limited to the description above.

The electronic device 100 is operatively connectively to a trained artificial intelligence engine 200 to identify a plurality of electric power estimation data during a first period which corresponds to each of the plurality of ESSs. Here, the first period may be a period in the future from a corresponding point in time, and the artificial intelligence engine 200 may obtain weather prediction data which are data obtained by predicting weather circumstances in the future from the corresponding point in time from the weather information server 400. For example, the first period may be a range within 48 hours from a corresponding point in time. The weather prediction data may include information predicted with respect to the first period in relation to a data item (or data attribute) similar to the above-mentioned weather data such as temperature, solar radiation quantity, wind speed, precipitation probability, humidity, weather classification information, and the like. Further, by using latitude and longitude information included in such weather prediction data, the weather prediction data may be mapped with respect to each of the plurality of ESSs. The artificial intelligence engine 200 may calculate such weather prediction data to output the electric power estimation data. It should be noted that an artificial intelligence engine 200, as described herein, is trained with a correlation between the weather data and the electric power data such that when the weather prediction data with respect to each of the plurality of ESSs are inputted, the electric power estimation data with respect to each of the plurality of ESSs may be outputted.

According to an aspect, the electric power estimation data may include information estimated with respect to a second period in relation to a data item similar to the electric power data, such as a power generation amount, a charge amount, a discharge amount, a facility electric power consumption amount, and the like. For example, the electric power estimation data may include information estimated with respect to a power generation amount, a charge amount, a discharge amount, and a facility electric power consumption amount for each unit time of a second period. For example, in a case in which the second period is 00:00 to 24:00 on Aug. 3, 2024, and the unit time is one hour, electric power estimation data with respect to the first ESS 510 may include information estimated with respect to a power generation amount, a charge amount, a discharge amount, and a facility electric power consumption amount for each time of a one-hour interval on Aug. 3, 2024.

According to an aspect, the electronic device 100 may identify first electric power estimation data corresponding to the first ESS 510. The electronic device 100 may, based on the first electric power estimation data, identify at least one second ESS 610 that matches the first ESS 510. For this, the electronic device 100 may, based on the first electric power estimation data, identify electric power supply data for each unit time for one or more unit times which are estimated with respect to a first period of the first ESS 510. Here, the electric power supply data for each unit time may be information as to whether a facility electric power consumption amount of a facility at which a plurality of ESSs are installed may be supplied based on an electric power amount stored in the first ESS 510 and a power generation amount corresponding to the first ESS 510, and may include an electric power supply value. Specifically, the electric power supply value may be a value obtained by estimating whether a facility electric power consumption amount of a facility at which a plurality of ESSs are installed may be supplied based on an electric power amount stored in each of the plurality of ESSs and a power generation amount corresponding to each of the plurality of ESSs, with respect to a corresponding unit time. The electric power amount stored in each of the plurality of ESSs may be calculated by a difference between a charge amount and a discharge amount. For example, an electric power supply value for each unit time of the first ESS 510 may be a value corresponding to a difference between a sum of the electric power amount and the power generation amount of the first ESS 510, which are estimated for each unit time, and a facility electric power consumption amount of the first ESS 510. A negative numerical (e.g., below zero) or zero electric power supply value may signify that the first ESS 510 and a power generator connected thereto are estimated to be unable to supply electric power to a facility for a corresponding unit time. Thus, the corresponding facility may receive electric power distributed from an external system of an absolute value of the electric power supply value for use. On the contrary, a positive numerical electric power supply value (e.g., above zero) may signify that the first ESS 510 and a power generator connected thereto are estimated to be able to supply electric power to a facility for a corresponding unit time. Thus, the corresponding facility may have a surplus of electric power of an absolute value of the electric power supply value. The electric power supply data for each unit time may include the electric power supply value and information as to whether electric power is sufficiently supplied for the respective unit time, which is identified based on a positive or negative number of the electric power supply value. For example, electric power supply data for a unit time of first electric power estimation data may include information indicating an electric power supply value and an electric power surplus of 14.8 kWh, which may indicate that the first ESS 510 is expected to have a surplus electric power by 14.8 kWh at the corresponding unit time. In another example, the electric power supply data for a unit time of the first electric power estimation data may include information indicating an electric power supply value and an electric power shortage of −6.5 kWh, which may indicate that the first ESS 510 is expected to have a shortage of electric power by 6.5 kWh at the corresponding unit time.

In some aspects, the artificial intelligence engine 200 may immediately output an electric power supply value for each unit time as electric power estimation data. In this case, the electronic device 100 may calculate a difference between a charge amount and a discharge amount, and further determine a difference value between the difference value, of charge and discharge amounts, and a facility electric power consumption amount, thereby identifying the corresponding value outputted from the artificial intelligence engine 200 as the electric power supply value for each unit time without performing a process of identifying the electric power supply value.

The electronic device 100 may identify at least one ESS which is estimated to have an electric power supply state opposite to that of the first ESS 510 from at least one portion of a unit time based on the electric power supply data for each unit time. As used herein, an “opposite” electric power supply state of a first ESS relative to a second ESS refers to complementary states (e.g., an electric power surplus state vs. an electric power shortage state) of the first ESS and the second ESS and may be identified by the opposite signs of their respective electric power supply number values. For example, in a case in which the first ESS 510 is estimated to have an electric power supply value, with respect to a specific unit time, that is a positive number (e.g., a surplus of electric power), the electronic device 100 may identify at least one ESS which is estimated to have an electric power supply value that is a negative number (e.g., a shortage of electric power). In another example, in a case in which the first ESS 510 is estimated to have an electric power supply value that is a negative number with respect to a unit time (e.g., to have a shortage of electric power), the electronic device 100 may identify at least one ESS which is estimated to have an electric power supply value that is a positive number (e.g., a surplus of electric power).

FIG. 5 is an example table of first electric power estimation data of a first ESS and second electric power estimation data of an ESS that is identified to have an electric power supply state that is opposite to that of the first ESS according to an aspect.

A first electric power estimation data 501 indicates that the first ESS 510 may sufficiently provide power for a facility electric power consumption amount only with a power generation amount from 7:00 to 17:00. The electric power is in a surplus in order for the first ESS 510 to be continuously charged, thereby causing an ESS electric power amount of the first ESS 510 to continuously increase from 7:00 to 17:00. Therefore, with respect to a unit time in a daytime zone of the first ESS 510, an electric power supply state may be identified to be an electric power surplus. However, second electric power estimation data 601 indicates that electric power amount of an ESS is continuously close to 0, and a power generation amount is smaller than a facility electric power consumption amount. In this case, an electric power supply state of the corresponding ESS may be identified to be an electric power shortage and thus, the corresponding ESS has an electric power supply state opposite to that of the first ESS 510.

The electronic device 100 may, based on condition information of the first ESS 510, identify at least one second ESS 610 of at least one ESS which is estimated to have an electric power supply state opposite to that of the first ESS 510. Here, the condition information of the first ESS 510 may satisfy at least one of various conditions such as a cost condition, a distance condition, a compatibility condition, a connection condition, and the like. The condition information may be set by a user of the first ESS 510 via the first terminal 520 associated with the first ESS 510.

According to an aspect, a cost condition may signify a price which is to be applied when electric power of the first ESS 510 is determined to be transferred or not. Some examples of the cost condition may be a condition related to a minimal price for each unit or a minimal total price when the electric power of the first ESS 510 is transfer to, or a maximal price for each unit or a maximal total price when electric power to be stored in the first ESS 510 received from a second ESS 510. In some aspects, the exchange of electrical power to and/or from another ESS based on a determination of electric power supply state, value, and the other ESS, as described herein, may involve a sales. In some aspects, a sales prices condition may be set to vary for each time zone, or may be set to vary depending on a distance from an ESS for power transfer. For example, because it is predicted that an ESS which is closer may have higher efficiency during an electric power exchange, diversification of a condition such as applying a relatively high price for a purchase with respect to a close ESS, and applying a relatively low price for sales with respect thereto is also possible.

According to an aspect, a distance condition may signify a condition related to a maximal distance which is to be applied when the electric power of the first ESS 510 is exchanged (i.e., transferred to or received from), and which is set by an owner of the first ESS 510 through the first terminal 520 corresponding to the first ESS 510. In some aspects, because efficiency decreases during an electric power exchange as a distance increases, in consideration thereof, an owner of the first ESS 510 may set a condition of maximum distance, or the like through the first terminal 520.

According to an aspect, a compatibility condition may be a condition related to compatibility which is determined according to a basic feature of the first ESS 510 such as a type of the first ESS 510 or a connection method thereof with an electric grid. Further, a connection condition may be a condition as to whether being connected to an electric grid which is capable of an electric power exchange with the first ESS 510. Such compatibility condition and connection condition may be a condition determined by a basic feature of the first ESS 510 or an infrastructure-environmental feature thereof.

According to an aspect, the electronic device 100 may not apply at least one portion of a condition included in the condition information in a case in which a magnitude of an absolute value of an electric power supply value, is equal or greater than a threshold value. The electric power supply value is determined as a difference between an available electric power (e.g., a sum of an electric power amount of the first ESS 510 and a power generation amount corresponding to the first ESS 510) and a facility electric power consumption amount by each unit time. For example, the electronic device 100 may not apply a condition set by the first terminal 520 such as a cost condition, a distance condition or the like with respect to a corresponding unit time in a case an electric power amount remaining as a surplus at the first ESS 510 is greater than the threshold value or the electric power amount is lower than another predefined threshold value such that the first ESS 510 is at a power shortage risk. In the case in which the electric power amount remaining as a surplus at the first ESS 510 is greater than a predefined threshold value, power transfer may be performed regardless of one or more condition information of the first ESS 510. For example, the power transfer is performed when cost is lower than the cost condition. In another example, the power may be received at a higher cost condition (e.g., fee greater than threshold value) when the first ESS is at a power shortage threat due to estimating a higher power consumption relative to estimated power availability. Thus, in such cases, the electronic device 100 may identify the second ESS 610 without applying at least one portion of the conditions.

In another example, a condition set by the first terminal 520 such as a cost condition, a distance condition or the like is not applied when an electric power supply state of the first ESS 510 corresponds to an electric power shortage in at least one portion corresponding to a peak time zone in a unit time may be provided. For example, a daytime zone of a day with a heat wave forecast, a nighttime zone of a day with a cold wave forecast or the like may be set as a peak time zone, and, in a case in which an electric power supply state of the first ESS 510 corresponds to an electric power shortage at a unit time included in a peak time zone of the unit time, because it might be economic to purchase electric power from another ESS despite little unsuitable conditions rather than receiving and using electric power distributed from an external system, the electronic device 100 may identify the second ESS 610 without applying at least one portion of the conditions included in the condition information also in such a case.

The electronic device 100 may identify at least one second ESS 610 to determine whether to perform an electric power exchange with the first ESS 510 based on at least one portion of the conditions disclosed herein. The electronic device 100 may deliver power transfer information related to an electric power exchange along with a notification for indicating that an electric power transfer between the first terminal 520 corresponding to the first ESS 510 and the second terminal 620 corresponding to the second ESS 610 is possible to the same.

Specifically, the electronic device 100 may deliver transfer information related to an electric power exchange along with a notification for indicating that an electric power transfer between the first terminal 520 corresponding to the first ESS 510 and the second terminal 620 corresponding to the second ESS 610 is possible to the same. Here, the transfer information may include various types of information which may assist in decision making and transfer closure such as a time corresponding to a corresponding unit time, an electric power supply value of the first ESS, an electric power supply value of a second ESS for power exchange, which are estimated with respect to the corresponding unit time, information of a price for each unit, a total price, and the like. The electronic device 100 may provide information related to a plurality of candidate unit times which are capable of an electric power transfer to the first terminal 520, and, when one of the same is selected, the electronic device 100 may deliver transfer information related to a corresponding unit time.

In some aspects, when the electric power transfer ready information is identified from the first terminal 520 and the second terminal 620, the electronic device 100 may identify that a decision for electric power transfer has been closed and determine that the transfer is “ready” to perform an electric power exchange between the first ESS 510 and the second ESS 610. If the electric power transfer ready information is not identified, the electronic device 100 may identify that a decision for electric power transfer is not closed, and may determine not to perform an electric power exchange between the first ESS 510 and the second ESS 610.

The electronic device 100 may control the first ESS 510 and the second ESS 610 in order for an electric power exchange to occur at a determined amount and time for uninterrupted supply of the electric power at the receiving ESS. The time for electrical power exchange may be determined based on a first ESS 510 storage capacity, a second ESS 610 storage capacity, and a storage capacity of an electric grid between the first ESS 510 and the second ESS 610 at various time periods. For example, the electric device 100 estimates that a first ESS 100 would be at a “shortage” electric power supply state at a future time period (e.g., in the evening) and further estimates that the electric grid between the first ESS 510 and the second ESS 610 would be at full capacity and unable to transfer power from the second ESS 610 to the first ESS 510 at the same future time period. In the example scenario, the electric device 100 identifies a time period before the future time period (i.e., before a “shortage” state at the first ESS 510) when the electric grid has storage capacity for electric power transfer from the second ESS 610 to the first 510 for electric power availability before first ESS 510 is electricity deficient. In another scenario of the same example, the electronic device 100 may estimate that the second ESS 610 reaches a “surplus” electric power supply state for electric power exchange at a time period sufficiently close to that of the future time period, when the first ESS 510 would be at a “shortage” state. Here, the electric device 100 may control the second ESS 610 and the first ESS 510 for real-time or near real-time electric power transfer from the second ESS 610 to the second ESS 510. Accordingly, monitoring and controlling various types of circumstance information as to whether there is a space in a capacity of an ESS from and into which electric power is to be discharged and introduced or in an electric grid and the like, a point in time of an electric power exchange may be determined.

According to an aspect, a power transfer information, or an electric power transfer ready information having the same, may include potential error information as determined and transmitted by the electronic device 100. Such power transfer information may be provided to users of the ESSs via their respective terminals, for example, as a notification. The potential error information may provide a probability of error with respect to one or more electric power data 512 and/or weather data 401. In addition, the potential error information may provide an estimated ESS electric power and an actual (measured) ESS electric power for comparison. At least a portion of the potential error information may be preset based on, for example, climate seasons, time of a year, geographical location, and any combination thereof. In an aspect, the electric power transfer ready information that indicates that the exchange is approved to occur may be modified based on the potential error information. A high probability of error or a difference between estimated and actual ESS electric power, above a predetermined threshold value, may cause incorrect estimation of ESS electric power at the ESS. To this end, the electric power transfer may be cancelled, for example, automatically, with input, or both, based on the probability of errors included in the power transfer information. For example, an electric power transfer is automatically cancelled based on the difference between an estimated electric power of 10 kWh and an actual measured electric power of 5 kWh. In another example, the electronic device 100 may notify that there is a high probability that a weather forecast might be incorrect, and may also notify that a transfer may be cancelled in a case in which electric power data become different due to an incorrect weather forecast.

When a transfer of electric power is completed, the electronic device 100 may deliver a transfer account to a distribution database (not shown). In some aspects, the distribution database may be connected to a blockchain through a peer-to-peer (P2P) network, and, because the transfer account is stored in such a distribution database, speediness, integrity and security of a transfer may be guaranteed.

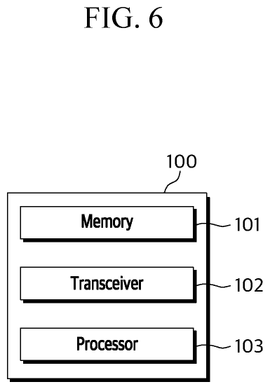

FIG. 6 is a block diagram of the electronic device 100 according to aspects of the disclosure.

According to an aspect, the electronic device 100 may include a memory 101 and a processor 103. The architecture of the electronic device 100 is not limited to the specific components and arrangement in FIG. 6 and may include other computing components as hardware, software, or both. In an aspect, the processor 103 may be included in a controller. The processor may be realized as one or more of application-specific integrated circuits (ASICs), central processing units (CPUs), graphics processing units (GPUs), general-purpose microprocessors, microcontrollers, and data processing devices.

The processor 103 may control an overall operation of the electronic device 100 and process data and signals. The processor 103 may be constituted with at least one hardware unit. Further, the processor 103 may be configured to execute at least one instruction stored in the memory 101.

For example, when at least one instruction is executed, the processor 103 is configured to identify a plurality of electric power estimation data during a first period for each of a plurality of ESSs, identify, based on first electric power estimation data during the first period which correspond to a first ESS of a plurality of ESSs, at least one second ESS that matches with the first ESS, identify electric power transfer intention information from each of a first terminal associated with the first ESS and a second terminal associated with the second ESS, and determine, based on the electric power transfer intention information identified from the first terminal and the second terminal, whether to perform an electric power exchange between the first ESS and the second ESS.

Various operations described as being performed by the electronic device 100 in the present disclosure may be performed with, with respect to at least one instruction stored in the memory 101, the processor 103 being configured to perform the aspects of the present disclosure when the at least one instruction is executed.

According to an aspect, the electronic device 100 may additionally include a transceiver 102 for performing wired and/or wireless communication. The electronic device 100 may communicate with an external electronic device by using the transceiver 102. The external electronic device may be a terminal or a server. In some aspects, the electronic device 100 may communicate with external systems, devices, applications, hardware components, or software components. Further, a communication technology used by the transceiver 102 may include global system for mobile communication (GSM), code division multi-access (CDMA), long-term evolution (LTE), 5^{th} generation global cellular standard (5G), wireless LAN (WLAN), wireless-fidelity (Wi-Fi), Bluetooth™, radio frequency identification (RFID), infrared data association (IrDA), ZigBee, near-field communication (NFC) and the like.

The electronic device according to aspects of the disclosure may include a processor, a memory for storing and executing program data, a permanent storage such as a disk drive, and/or a user interface device such as a communication port, a touch panel, a key and/or a button that communicates with an external device. Methods implemented as software modules or algorithms are computer-readable codes and/or program instructions executable on the processor, and may be stored on a computer-readable storage medium. The memory 101 may be a non-transitory and/or transitory computer readable medium. Here, the computer-readable storage medium may include a magnetic storage medium (e.g., a read-only memory (ROM), a random-access memory (RAM), a floppy disk, a hard disk, or the like), an optical reading medium (e.g., a CD-ROM or a digital versatile disc (DVD)), or the like. The computer-readable storage medium may be dispersed to computer systems connected by a network in order for computer-readable codes to be stored and executed in a dispersed manner. The medium may be read by a computer, stored in the memory, and executed by the processor.

The present disclosure may be represented by functional block configurations and various processing steps. These functional blocks may be implemented in any number of hardware and/or software configurations that execute the functions. For example, some aspects may adopt integrated circuit configurations such as a memory, a processor, a logic circuit, and a look-up table that may execute various functions by control of one or more microprocessors or other control devices. Aspects of the present disclosure may be executed by software programming or software elements implementing programming or scripting languages such as C, C++, Java, and assembler language, including various algorithms implemented by combinations of data structures, processes, routines, or of other programming configurations. Functional aspects may be implemented by algorithms executed by one or more processors. In addition, aspects of the disclosure may adopt the related art for electronic environment setting, signal processing, and/or data processing. The terms “mechanism”, “element”, “means”, and “configuration” may be widely used and are not limited to specific mechanical and physical configurations. The terms may include the meaning of a series of routines of software in association with a processor or the like.

What is claimed is:

1. An electronic device for an electric power transfer, the electronic device comprising:
a transceiver;
a processor; and
a memory storing at least one instruction,
wherein, when the at least one instruction is executed by the processor, the processor is configured to:
identify a plurality of electric power estimation data during a first period which correspond to each of a plurality of energy storage systems (ESSs);
identify, based on first electric power estimation data of the plurality of electric power estimation data during the first period of a first ESS of the plurality of ESSs, at least one second ESS that match the first ESS;
identify electric power transfer ready information from a first terminal associated with the first ESS and a second terminal associated with the second ESS; and
determine, based on the electric power transfer ready information identified from the first terminal and the second terminal, to perform an electric power exchange between the first ESS and the second ESS.

2. The electronic device of claim 1, wherein the processor is further configured to:
control, based on determining to perform the electric power exchange between the first ESS and the second ESS, the first ESS and the second ESS in order for an electric power exchange to occur by an electric power amount defined between the first ESS and the second ESS.

3. The electronic device of claim 1, wherein the processor is further configured to:
obtain the first electric power estimation data during a first period of the first ESS that are outputted from an artificial intelligence engine based on weather prediction data of the first period of a region corresponding to a location of the first ESS that are inputted in the artificial intelligence engine,
wherein the artificial intelligence engine is an artificial intelligence model which is constructed by learning a correlation between weather data during a second period of a region corresponding to a location of at least one ESS of the plurality of ESSs and electric power data corresponding to the second period with respect to the at least one ESS of the plurality of ESSs, wherein the electric power data includes at least one of a power generation amount, a charge amount, a discharge amount, and a facility electric power consumption amount.

4. The electronic device of claim 3, wherein the correlation between the weather data during the second period and the electric power data comprises:
a first correlation related to a proportionality with respect to a solar radiation quantity of a solar power generation amount that is inversely proportional to a temperature thereof;
a second correlation relates to a proportionality with respect to wind speed of a wind power generation amount; and
a third correlation with respect to a U letter-shaped relationship with respect to a temperature of the facility electric power consumption amount, wherein the solar power generation amount and the wind power generation amount is at least a portion of the power generation amount.

5. The electronic device of claim 3, wherein the weather prediction data comprise at least one of a temperature, a sunshine amount, and a wind speed which are predicted with respect to the first period of the region.

6. The electronic device of claim 1, wherein the processor is further configured to:
determine, based on the first electric power estimation data, electric power supply data for each unit time of unit times which are estimated with respect to the first period of the first ESS, wherein the electric power supply data for each unit time comprise data estimating whether a facility electric power consumption amount of the first ESS is supplied with an electric power amount of the first ESS and a power generation amount corresponding to the first ESS for the each unit time;
identify, based on the electric power supply data for each unit time, at least one ESS determined to have an electric power supply state that is opposite to that of the first ESS in at least one portion of the unit times; and
identify, based on condition information of the first ESS, the at least one second ESS of the at least one ESS determined to have the electric power supply state that is opposite to that of the first ESS.

7. The electronic device of claim 6, wherein the processor is further configured to:
determine the electric power supply data for each unit time based on the first electric power estimation data, wherein the electric power supply data further comprises a sum of the electric power amount of the first ESS and the power generation amount corresponding to the first ESS and a value estimated by a difference of the sum and the facility electric power consumption amount by the each unit time.

8. The electronic device of claim 7, wherein the processor is further configured to:
identify the at least one second ESS that matches at least one condition included in the condition information of the first ESS, wherein the condition in the condition information is any one of a cost condition, a distance condition, a compatibility condition and a connection condition, and wherein the at least one second ESS is of the at least one ESS estimated to have an electric power supply state that is opposite to that of the first ESS in the at least one portion of the unit time.

9. The electronic device of claim 8, wherein the processor is further configured to:
identify that a magnitude of the value estimated by the difference of the sum and the facility electric power consumption amount by each unit time is equal to or greater than a threshold value; and
identify, with respect to the at least one portion of the unit time during which the magnitude of the value estimated by the difference is equal to or greater than the threshold value, the at least one second ESS without applying at least one condition included in the condition information.

10. The electronic device of claim 9, wherein the processor is further configured to:
determine that an electric power supply state of the first ESS is an electric power shortage in at least one portion corresponding to a peak time zone of the unit times; and
identify, with respect to the at least one portion corresponding to the peak time zone of the unit times in which the electric power supply state of the first ESS corresponds to an electric power shortage, the at least one second ESS without applying at least one portion of the condition included in the condition information.

11. The electronic device of claim 1, wherein the processor is further configured to:
transmit transfer information related to the electric power exchange between the first ESS and the second ESS to each of the first terminal and the second terminal; and
identify the electric power transfer ready information comprising information indicating a decision for an electric power transfer and an electric power amount to be transferred based on the electric power transfer information from each of the first terminal and the second terminal.

12. A method for an electric power transfer of an electronic device, the method comprising:
identifying a plurality of electric power estimation data during a first period of a plurality of ESSs;
identifying at least one second ESS that match a first ESS based on first electric power estimation data during the first period of the first ESS of a plurality of ESSs;
identifying, based on first electric power estimation data of the plurality of electric power estimation data during the first period of a first ESS of the plurality of ESSs, at least one second ESS that matches the first ESS;
identifying electric power transfer ready information from a first terminal associated with the first ESS and a second terminal associated with the second ESS; and
determining, based on the electric power transfer ready information identified from the first terminal and the second terminal, to perform an electric power exchange between the first ESS and the second ESS.

13. The method according to claim 12, further comprising:
controlling, based on determining to perform the electric power exchange between the first ESS and the second ESS, the first ESS and the second ESS in order for an electric power exchange to occur by an electric power amount defined between the first ESS and the second ESS.

14. The method according to claim 12, further comprising:
obtaining the first electric power estimation data during a first period of the first ESS that are outputted from an artificial intelligence engine based on weather prediction data of the first period of a region corresponding to a location of the first ESS that are inputted in the artificial intelligence engine,
wherein the artificial intelligence engine is an artificial intelligence model which is constructed by learning a correlation between weather data during a second period of a region corresponding to a location of at least one ESS of the plurality of ESSs and electric power data corresponding to the second period with respect to the at least one ESS of the plurality of ESSs, wherein the electric power data includes at least one of a power generation amount, a charge amount, a discharge amount, and a facility electric power consumption amount.

15. The method according to claim 12, further comprising:
determining, based on the first electric power estimation data, electric power supply data for each unit time of unit times which are estimated with respect to the first period of the first ESS, wherein the electric power supply data for each unit time comprise data estimating whether a facility electric power consumption amount of the first ESS is supplied with an electric power amount of the first ESS and a power generation amount corresponding to the first ESS for the each unit time;
identifying, based on the electric power supply data for each unit time, at least one ESS determined to have an electric power supply state that is opposite to that of the first ESS in at least one portion of the unit times; and
identifying, based on condition information of the first ESS, the at least one second ESS of the at least one ESS determined to have the electric power supply state that is opposite to that of the first ESS.

16. The method according to claim 15, further comprising:
determining the electric power supply data for each unit time based on the first electric power estimation information, wherein the electric power supply data further comprises a sum of the electric power amount of the first ESS and the power generation amount corresponding to the first ESS and a value estimated by a difference of the sum and the facility electric power consumption amount by the each unit time.

17. The method according to claim 16, further comprising:
identifying the at least one second ESS that matches at least one condition included in the condition information of the first ESS, wherein the condition in the condition information is any one of a cost condition, a distance condition, a compatibility condition and a connection condition, and wherein the at least one second ESS is of the at least one ESS estimated to have an electric power supply state that is opposite to that of the first ESS in the at least one portion of the unit time.

18. The method according to claim 17, further comprising:
identifying that a magnitude of the value estimated by the difference of the sum and the facility electric power consumption amount by each unit time is equal to greater than a threshold value; and
identifying, with respect to the at least one portion of the unit time during which the magnitude of the value estimated by the difference is equal to greater than the threshold value, the at least one second ESS without applying at least one condition included in the condition information.

19. The method according to claim 12, further comprising:
transmitting transfer information related to the electric power exchange between the first ESS and the second ESS to each of the first terminal and the second terminal; and
identifying the electric power transfer ready information comprising information indicating a decision for an electric power transfer and an electric power amount to be transferred based on the electric power transfer information from each of the first terminal and the second terminal.

20. A non-transitory computer-readable storage medium storing information that, when executed by a processor, cause the processor to perform a method for an electric power transfer on a computer, the method comprising:
identifying a plurality of electric power estimation data during a first period of a plurality of ESSs;
identifying, based on first electric power estimation data of the plurality of electric power estimation data during the first period of a first ESS of the plurality of ESSs, at least one second ESS that matches the first ESS;
identifying electric power transfer ready information from a first terminal associated with the first ESS and a second terminal associated with the second ESS; and
determining, based on the electric power transfer ready information identified from the first terminal and the second terminal, to perform an electric power exchange between the first ESS and the second ESS.
